(19) United States
(12) Patent Application Publication
(10) Pub. No.: US 2005/0111454 A1
(43) Pub. Date: May 26, 2005

(54) Method, apparatus and system for intelligently and dynamically routing mobile internet protocol packets

(76) Inventors: Ranjit S. Narjala, Hillsboro, OR (US); Farid Adrangi, Lake Oswego, OR (US); Michael B. Andrews, Beaverton, OR (US)

Correspondence Address: INTEL CORPORATION, P.O. BOX 5326, SANTA CLARA, CA, 95056-5326, US

(21) Appl. No.: 10/723,916

(22) Filed: Nov. 25, 2003

(51) Int. Cl. H04L 12/56

(52) U.S. Cl. 370/392; 370/395.5

(57) ABSTRACT

A mobile node may dynamically and intelligently route mobile IP packets. In one embodiment of the present invention, a method, apparatus and system are disclosed whereby a mobile node may include a policy manager to determine how to route mobile IP packets. Specifically, the policy manager may include various filters that provide information to a mobile IP driver on the mobile node to enable the driver to determine whether to apply mobile IP headers to outgoing packets prior to transmission.

### FIELD

The present invention relates to the field of mobile computing, and, more particularly to a method, apparatus and system for intelligently and dynamically routing mobile internet protocol (“IP”) packets.

### BACKGROUND

Use of mobile computing devices (hereafter “mobile nodes”) such as laptops, notebook computers, personal digital assistants (“PDAs”) and cellular telephones is becoming increasingly popular today. These mobile nodes enable users to move from one location to another (“roam”), while continuing to maintain their connectivity to the same network. Given its increasing popularity, it is unsurprising that most corporate (“enterprise”) networks today attempt to facilitate fast and secure mobile computing.

In order to roam freely, networks typically conform to one or more industry-wide mobile IP standards. More specifically, the Internet Engineering Task Force (“IETF”) has promulgated roaming standards (Mobile IPv4, IETF RFC 3344, August 2002, hereafter “Mobile IPv4,” and Mobile IPv6, IETF Mobile IPv6, Internet Draft draft-ietf-mobileip-ipv6-24.txt (Work In Progress), June 2003, hereafter “Mobile IPv6”) to enable mobile node users to move from one location to another while continuing to maintain their connectivity to the same network.

### BRIEF DESCRIPTION OF THE DRAWINGS

The present invention is illustrated by way of example and not limitation in the figures of the accompanying drawings in which like references indicate similar elements, and in which:

FIG. 1 illustrates a known corporate intranet structure;

FIG. 2 illustrates conceptually an embodiment of the present invention;

FIG. 3 illustrates further details of an embodiment of the present invention;

FIG. 4 is a flow chart illustrating packet processing for packets transmitted from a mobile node according to embodiments of the present invention; and

FIG. 5 is a flow chart illustrating packet processing for packets received on a mobile node according to an embodiment of the present invention.

### DETAILED DESCRIPTION

Embodiments of the present invention provide a method, apparatus and system for mobile nodes to intelligently and dynamically route mobile IP packets. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

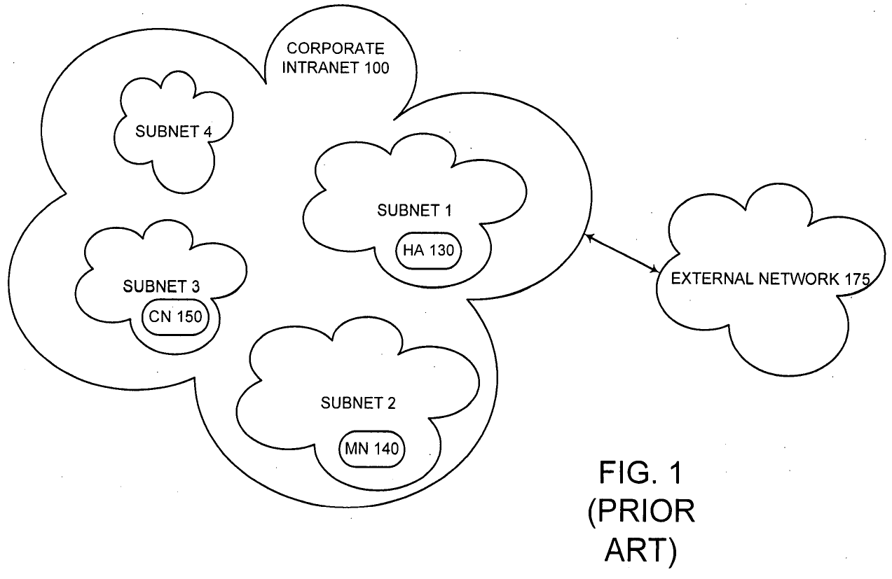

FIG. 1 illustrates a known corporate intranet (“Corporate Intranet 100”) structure. Corporate Intranet 100 may include both wired and wireless networks and may comprise multiple subnets. A subnet refers to a portion of an organization's network interconnected to other subnets by a routing element. Subnets are well known to those of ordinary skill in the art and further description thereof is omitted herein.

Mobile nodes that conform to mobile IP standards today may roam freely across subnets within Corporate Intranet 100. These mobile nodes (e.g., “MN 140”) typically apply mobile IP to all transmissions and are therefore able to maintain their current transport connections and constant reachability. The term “apply mobile IP” is well known to those of ordinary skill in the art, and typically includes the application of mobile IP headers to packets prior to transmission, and correspondingly the removal of these mobile IP headers when packets are received. When MN 140 exits its home subnet on Corporate Intranet 100, it may register with a home agent (“HA 130”). During the registration process, MN 140 informs HA 130 of MN 140's home address (i.e., the invariant address assigned to MN 140) and its “care-of address” (hereafter “COA”), namely MN 140's address on its new subnet. MN 140 may obtain COAs via Dynamic Host Configuration Protocol (“DHCP”) or other similar protocols. HA 130 thereafter intercepts all IP packets from correspondent nodes (illustrated as “CN 150”) addressed to MN 140 and reroutes the packets to MN 140's COA using IP tunneling. IP tunneling is well known to those of ordinary skill in the art and further description thereof is omitted. Additionally, although CN 150 is illustrated as residing within Corporate Intranet 100, it will be readily obvious to those of ordinary skill in the art that CN 150 may reside on any foreign subnet, including subnets on networks outside Corporate Intranet 100 (e.g., External Network 175). As MN 140 moves from one foreign subnet to another, to ensure that HA 130 is able to properly route packets to MN 140, MN 140 must continuously update HA 130 with its new COA. This routing via HA 130 introduces additional latency and routing overhead.

Certain network traffic, however, does not benefit from any mobility enhancements. In other words, although MN 140 may apply mobile IP to all packets originating from MN 140, certain types of these packets may not benefit from the additional mobility layer. An example of such traffic is Hyper Text Transport Protocol (“HTTP”) traffic. HTTP is well known to those of ordinary skill in the art and a detailed description thereof is omitted herein. In summary, HTTP connections are short-lived Transport Control Protocol (“TCP”) connections. For every web page requested from a client browser, a new TCP connection may be established, and the page may be downloaded over that TCP connection. Once the data has been downloaded, that connection is torn down and a new connection may be established for the next data request. These connections are typically so short-lived that any changes in connectivity due to MN 140's roaming will result in no visible effect to the user. As a result, applying mobile IP to this type of traffic provide little to no additional enhancements for mobility. These packets will have to be unnecessarily tunneled via HA 130 in both directions.

Another example of packets that do not benefit from mobility is packets destined for the same subnet. In other words, if MN 140 is transmitting packets to CN 150 which happens to reside on MN 140's current subnet, application of mobile IP may simply add a layer of unnecessary complexity to packet routing. With mobile IP headers, the packets from MN 140 are routed to HA 130 (likely on a different subnet) and back to the originating subnet, to CN 150. Again, application of mobile IP adds little to no value in this scenario.

According to an embodiment of the present invention, mobile nodes such as MN 140 may dynamically and intelligently determine when to apply mobile IP to packets originating from MN 140. In one embodiment, this determination is performed on a per-packet basis while in an alternate embodiment, the determination may be done on predefined sets of packets. According to embodiments of the invention, MN 140 may be configured with one or more sets of policies to enable it to determine which traffic flows may be optimized in this manner. Thus, for example, MN 140 may be configured with a default set of traffic flow patterns, based on well-know port numbers (e.g., port 80 for HTTP traffic) or particular packet header types. In one embodiment, the default set of policies may be modified by the user, to optimize performance. Regardless of whether default or modified policies are applied, according to embodiments of the present invention, application of these policies to outgoing packets on MN 140 may enable MN 140 to optimize its performance by deciding when to apply mobile IP to a packet and when to bypass this application.

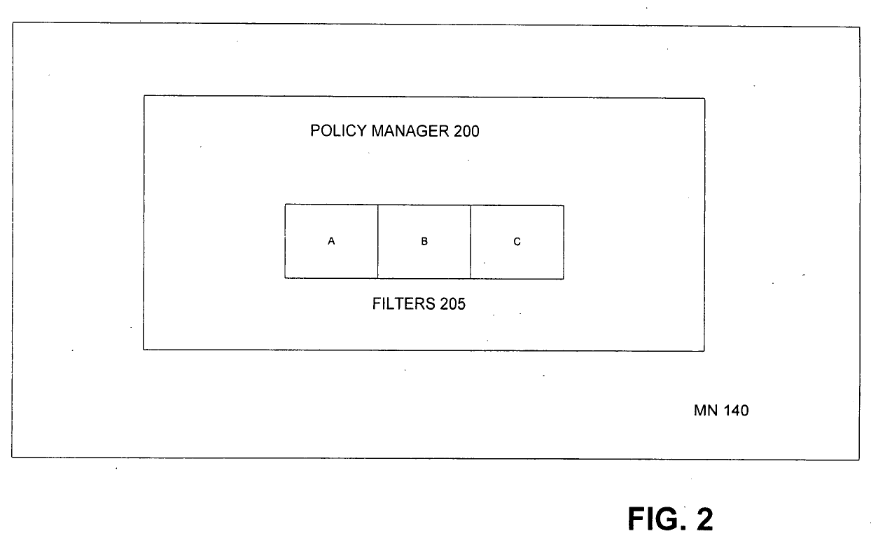

FIG. 2 illustrates conceptually an embodiment of the present invention. As illustrated, MN 140 may include a set of policies in a policy manager module (“Policy Manager 200”). Policy Manager 200 may filter all packets that are transmitted from MN 140, and if a packet matches the filters (“Filters 205” including filters A, B and C) in Policy Manager 200, MN 140 may send out the packet without applying mobile IP to the packet. If so, the packet may be transmitted with the MN 140's COA as the source IP address, without any IP tunneling. The packet may therefore be transmitted directly to CN 150, and the reply from CN 150 may be transmitted directly back to MN 140 (via its COA). If, on the other hand, a packet does not match any of the filters in Policy Manager 200, mobile IP may be applied on the packet and the packet may be routed according to the typical mobile IP routing process described above with respect to FIG. 1.

According to an embodiment of the present invention, various filters may be included in Policy Manager 200 (e.g., Filters 205(A), 205(B) and 205(C), as illustrated). As described above, for example, one set of filters may examine the type of packet being transmitted (e.g., HTTP packets via port 80) and use this information to determine whether to apply mobile IP. If, for example, Policy Manager 200 determines that the packets are HTTP packets, MN 140 may bypass application of mobile IP to these packets and send the packets directly to CN 150 using its COA.

In an alternate example, another set of filters may examine the destination of the packets and use the destination to determine whether to apply mobile IP. Thus, Policy Manager 200 may be configured such that if CN 150 resides on the same subnet as MN 140's current subnet, packets from MN 140 to CN 150 may be transmitted directly (i.e., without being routed via HA 130). In other words, in this embodiment, regardless of the type of packet, Policy Manager 200 may enable additional optimization of packet routing by eliminating the need to route packets destined for the same subnet via HA 130. Packets from CN 150 to MN 140 may still be routed via HA 130, however, since MN 140 may continue to roam and CN 150 may have no means of identifying whether MN 140 is still on the same subnet. It will be readily apparent to those of ordinary skill in the art that the above filters are merely exemplary and that various other filters may also be implemented within Policy Manager 200 without departing from the spirit of embodiments of the present invention.

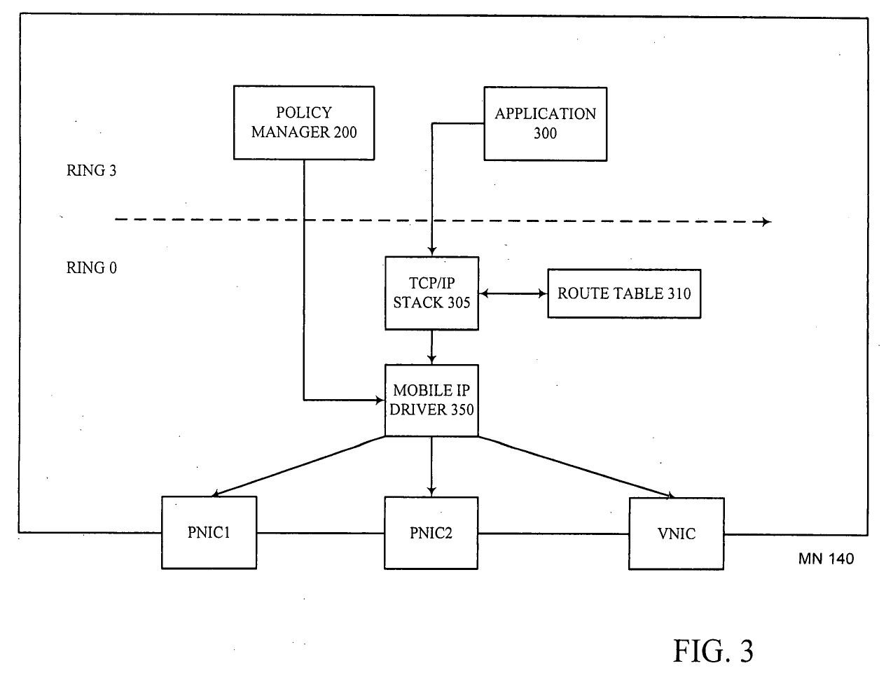

FIG. 3 illustrates further details of an embodiment of the present invention. As illustrated, MN 140 may be conceptually viewed as having a user space (typically referred to as “Ring 3”) and a kernel space (typically referred to as “Ring 0”). Policy Manager 200 and Application 300 reside in the Ring 3 space while the remaining IP routing functionality occurs in Ring 0 space. The concept of Ring 0 and Ring 3 are well known to those of ordinary skill in the art and further description thereof is omitted herein in order not to unnecessarily obscure embodiments of the present invention. When Application 300 transmits a packet from MN 140 to CN 150, the packet may be associated with a source IP address (MN 140's COA) and a destination IP address (CN 150). This packet may be processed by the TCP/IP stack on MN 140 (illustrated as “TCP/IP Stack 305”) prior to transmission from MN 140. TCP/IP stacks are also well known to those of ordinary skill in the art and further description thereof is omitted herein. In the illustrated example, MN 140 may include two adapters, a wired adapter (“PNIC1”) and a wireless adapter (“PNIC2”). Based on which adapter is currently active, TCP/IP Stack 305 may process the packet (e.g., look up entries in Route Table 310) and determine which adapter on MN 140 to utilize to transmit the packet.

According to one embodiment, MN 140 may also include a Policy Manager 200 and Mobile IP Driver 350. Mobile IP Driver 350 typically applies mobile IP to all packets transmitted from MN 140, after the packets are processed by TCP/IP Stack 305. In one embodiment of the present invention, Policy Manager 200 interacts with Mobile IP Driver 350 to determine how to selectively apply mobile IP to the packets. Thus, for example, if Policy Manager 200 determines based on its filters that the packets are HTTP packets that do not require mobile IP applied to them, this information may be provided to Mobile IP Driver 350. Mobile IP Driver 350 may therefore not apply mobile IP to the HTTP packets and the packets may be transmitted with MN 140's COA as its source address and without any mobile IP headers via an appropriate adapter. If, however, Policy Manager 200 does not filter the packet, Mobile IP Driver 350 may process the packet as usual (i.e., by adding a mobile IP header to the packet, or more specifically, by including a new source address (COA) and a new destination address (HA 130 address) to the packet) and transmit the packet using an appropriate physical NIC, even though the TCP/IP stack 305 sent the packet to the virtual NIC (“VNIC 315”). The use of virtual NICs on mobile nodes is well known to those of ordinary skill in the art and further description thereof is omitted herein in order not to unnecessarily obscure embodiments of the present invention.

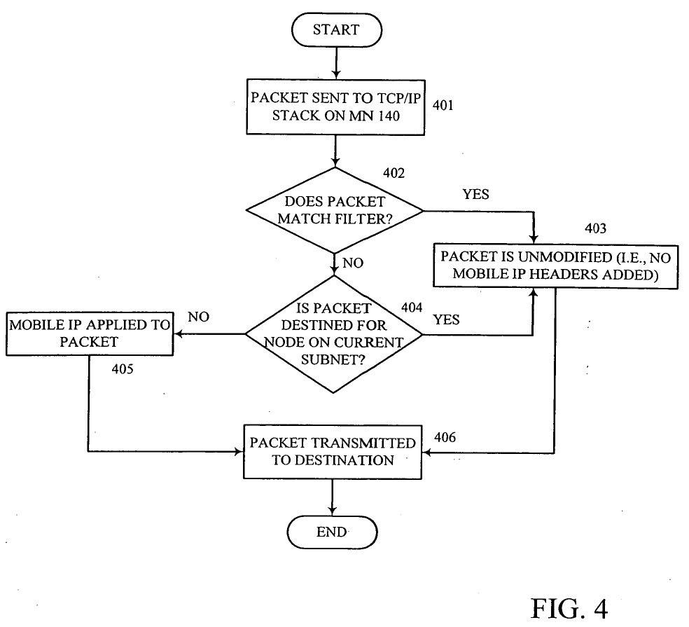

FIG. 4 is a flow chart illustrating packet processing for packets transmitted from MN 140. Although the following operations may be described as a sequential process, many of the operations may in fact be performed in parallel and/or concurrently. In addition, the order of the operations may be re-arranged without departing from the spirit of embodiments of the invention. In 401, a packet destined for CN 150 is sent (e.g., from an application on MN 140) to the TCP/IP stack on MN 140. The packet is examined in 402 to determine if it matches any filters in the policy engine. If it does match a filter, in 403, the packet may not be modified to add mobile IP headers. Instead, the source address of the packet is modified to MN 140's COA and the packet is transmitted in 406.

If, however, the packet does not match a filter, in 404, the packet may be examined further to determine whether the destination address is a node on the current subnet (i.e., whether CN 150 resides on MN 140's current subnet). If the packet is destined for a node on the current subnet, then the packet in 403 is unmodified, i.e. no mobile IP headers are added to the packet and the source address of the packet remains MN 140's home address. The packet may then be transmitted in 406. If the packet is destined for a node on a different subnet, Mobile IP Driver 350 may apply mobile IP to the packet in 405 and the packet may then be transmitted in 406. It will be readily apparent to those of ordinary skill in the art that additional filters may also be implemented without departing from the spirit of embodiments of the present invention. If optimization is desired, one or more of these filters may be used to determine whether to apply mobile IP to packets transmitted from MN 140.

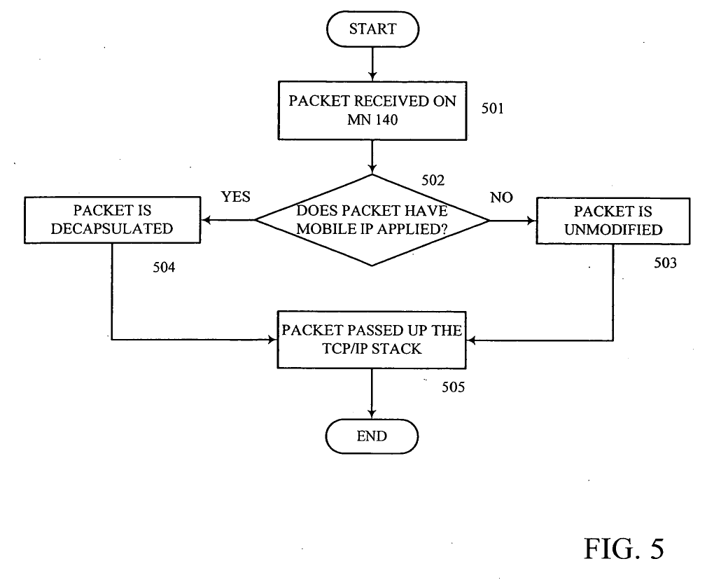

FIG. 5 is a flow chart illustrating packet processing for packets received on MN 140. Again, although the following operations may be described as a sequential process, many of the operations may in fact be performed in parallel and/or concurrently. In addition, the order of the operations may be re-arranged without departing from the spirit of embodiments of the invention. A packet is received in 501 by MN 140 and examined in 502 to determine whether mobile IP is applied to it. If the packet does not have mobile IP applied to it, in 503, the packet is unmodified and sent up the stack in 505. If, however, the packet does have mobile IP applied to it, the packet is decapsulated according to the MobileIP specifications in 504 prior to being sent up the stack in 505.

The mobile nodes and home agents according to embodiments of the present invention may be implemented on a variety of data processing devices. It will be readily apparent to those of ordinary skill in the art that these data processing devices may include various types of software, and may comprise any devices capable of supporting mobile networks, including but not limited to mainframes, workstations, personal computers, laptops, portable handheld computers, PDAs and/or cellular telephones. In an embodiment, mobile nodes may comprise portable data processing systems such as laptops, handheld computing devices, personal digital assistants and/or cellular telephones. According to one embodiment, home agents may comprise data processing devices such as personal computers, workstations and/or mainframe computers. In alternate embodiments, home agents may also comprise portable data processing systems similar to those used to implement mobile nodes.

According to an embodiment of the present invention, data processing devices may include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the data processing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of routing a packet on a mobile node, comprising:
establishing a policy manager on the mobile node;
examining the packet according to at least one filter in the policy manager; and
informing a driver whether to modify the packet.

2. The method according to claim 1 further comprising modifying the packet by adding a mobile IP header.

3. The method according to claim 2 wherein the mobile IP header includes a new source address and a new destination address.

4. The method according to claim 1 wherein the at least one filter includes criteria to identify a type of packet.

5. The method according to claim 4 wherein the type of packet includes at least one of a Hyper Text Transport Protocol (“HTTP”) packet, a User Datagram Protocol (“UDP”) packet and a Transport Control Protocol (“TCP”) packet.

6. The method according to claim 1 wherein the at least one filter includes a determination of an original destination IP address for the packet.

7. An article comprising a machine-accessible medium having stored thereon instructions that, when executed by a machine, cause the machine to route a packet on a mobile node by:
establishing a policy manager on the mobile node;
examining the packet according to at least one filter in the policy manager; and
informing a driver whether to modify the packet.

8. The article according to claim 7 wherein the instructions, when executed by the machine, further cause the machine to route the packet on the mobile node by adding a mobile IP header.

9. The article according to claim 8 wherein the mobile IP header includes a new source address and a new destination address.

10. The article according to claim 7 wherein the instructions, when executed by the machine, further cause the machine to route the packet on the mobile node by identifying a type of packet.

11. The article according to claim 10 wherein the type of packet includes at least one of a Hyper Text Transport Protocol (“HTTP”) packet, a User Datagram Protocol (“UDP”) packet and a Transport Control Protocol (“TCP”) packet.

12. The article according to claim 7 wherein the instructions, when executed by the machine, further cause the machine to route the packet on the mobile node by determining an original destination IP address for the packet.

13. A system for routing packets, comprising:
a mobile node;
a policy manager accessible by the mobile node, the policy manager including at least one filter; and
a driver on the mobile node, the driver capable of receiving instructions from the policy manager to modify the packet.

14. The system according to claim 13 wherein the driver is further capable of receiving instructions from the policy manager to modify the packet by adding a mobile IP header.

15. The system according to claim 14 wherein the mobile IP header includes a new source address and a new destination address.

16. The system according to claim 13 wherein the at least one filter in the policy manager includes criteria to identify a type of packet.

17. The system according to claim 16 wherein the type of packet includes at least one of a Hyper Text Transport Protocol (“HTTP”) packet, a User Datagram Protocol (“UDP”) packet and a Transport Control Protocol (“TCP”) packet.

18. The system according to claim 13 wherein the at least one filter in the policy manager includes a determination of an original destination IP address for the packet.

19. A method of routing a packet on a mobile node, comprising:
accessing at least one filter;
examining the packet on the mobile node according to the at least one filter; and
modifying the packet according to the at least one filter.

20. The method according to claim 19 wherein modifying the packet further comprises modifying the packet by adding a mobile IP header to the packet.

21. The method according to claim 20 wherein the mobile IP header includes a new source address and a new destination address.

22. The method according to claim 19 wherein the at least one filter includes criteria to identify a type of packet.

23. The method according to claim 22 wherein the type of packet includes at least one of a Hyper Text Transport Protocol (“HTTP”) packet, a User Datagram Protocol (“UDP”) packet and a Transport Control Protocol (“TCP”) packet.

24. The method according to claim 19 wherein the at least one filter includes a determination of an original destination IP address for the packet.
